(19) United States
(12) Patent Application Publication
(10) Pub. No.: US 2009/0223868 A1
(43) Pub. Date: Sep. 10, 2009

(54) CATALYST AND PROCESS FOR THE SELECTIVE HYDRODESULFURIZATION OF AN OLEFIN CONTAINING HYDROCARBON FEEDSTOCK

(76) Inventor: Opinder Kishan BHAN, Katy, TX (US)

Correspondence Address: SHELL OIL COMPANY, P O BOX 2463, HOUSTON, TX, 772522463, US

(21) Appl. No.: 12/398,022

(22) Filed: Mar. 4, 2009

Related U.S. Application Data
(63) Continuation-in-part of application No. 12/043,847, filed on Mar. 6, 2008.
(60) Provisional application No. 61/051,300, filed on May 7, 2008.

(51) Int. Cl. C10G 45/08; B01J 23/16; B01J 37/00

(52) U.S. Cl. 208/216 R; 502/102

(57) ABSTRACT

A catalyst composition comprising a special support of alumina and an amount of silica in the range of from 0.3 wt % to 10 wt % of the total weight of the support, a cobalt component, and a high concentration of a molybdenum component that exceeds 12 wt % of the total weight of the catalyst composition. The catalyst composition is highly active toward the desulfurization of an olefin-containing feedstock having a sulfur concentration while being selective toward the hydrogenation of the olefins contained in the feedstock and is used in a novel process for the selective desulfurization of an olefin-containing feedstock.

This application is a continuation-in-part application of prior application Ser. No. 12/043,847, filed Mar. 6, 2008, and this application claims the benefit of U.S. Provisional Application No. 61/051,300, filed May 7, 2008.

This invention relates to the selective hydrodesulfurization of an olefin-containing hydrocarbon feedstock.

Gasoline regulations are increasingly creating a need to treat various refinery streams and products, for example, cracked gasoline blending material, including coker naphtha and gasoline from a catalytic cracking unit, to remove undesirable sulfur that is contained in such refinery streams and products. One means by which sulfur may be removed from hydrocarbon streams that contain olefin compounds is through the use of various of the known catalytic hydroprocessing methods. A problem with the use of such catalytic hydroprocessing methods is that they typically tend to hydrogenate the olefin compounds as well as the sulfur compounds contained in the hydrocarbon feed stream that is being treated. When the treated hydrocarbon feed stream is used as a gasoline-blending component, usually, the presence of the olefins therein is desirable because of their relatively high-octane values and octane contribution to the gasoline pool.

Cracked gasoline blending material typically contains high concentrations of high-octane olefin compounds as well as concentrations of sulfur compounds. It is desirable to be able to catalytically desulfurize the cracked gasoline blending materials with a minimum of hydrogenation of the olefins contained in them, or, in other words, to selectively hydrodesulfurize the cracked gasoline blending material.

Disclosed in the prior art are many types of hydroprocessing catalysts and processes, and the prior art even discloses processes for the selective hydrodesulfurization of olefin containing hydrocarbon feedstock. For instance, in the recent patent application publication US 2006/0237345 is disclosed a process for the selective hydrodesulfurization of an olefin-containing hydrocarbon feedstock. This process uses a catalyst composition having a high content of a nickel component and an effective but small amount of a molybdenum component that are supported on a porous refractory oxide. The catalyst provides for the selective hydrogenation of sulfur compounds contained in the hydrocarbon feedstock with a minimal amount of olefin hydrogenation as compared to certain other hydrogenation catalysts.

U.S. Pat. No. 5,266,188 is one patent that discloses a process for the selective hydrotreating of a cracked naphtha using a catalyst comprising a Group VIB metal component (molybdenum is preferred), a Group VIII metal component (cobalt is preferred), a magnesium component, and an alkali metal component. The Group VIB metal is present in the catalyst in an amount in the range of from about 4.0 wt % to about 20.0 wt %, and the Group VIII metal component is present in the range of from about 0.5 wt % to about 10.0 wt %. The support is a refractory inorganic oxide that comprises magnesium and an alkali metal, and the refractory inorganic oxide can be alumina. The alumina will have an average pore diameter in the range of from about 30 to about 120 Angstroms and a surface area of at least 150 m²/g. There is no disclosure of a co-impregnation of the support with cobalt, molybdenum and potassium.

U.S. Patent Publication No. 2003/0183556 discloses a process for the selective hydrodesulfurization of naphtha which process uses a preferred catalyst that comprises a MoO₃ concentration of about 1 to 10 wt. % and a CoO concentration of about 0.1 to 5 wt. %. The median pore diameter of the catalyst is from about 60 Å to about 200 Å. The catalyst may be supported on an inorganic oxide that is preferably a high surface area alumina, but the form of the alumina is not disclosed (e.g., there is no teaching that the alumina is in the gamma form or any other transitional form). The support is preferably substantially free of contaminants, but the support may have an additive selected from the group consisting of phosphorus and metals or metal oxides from Group IA (alkali metals) of the Periodic Table.

U.S. Pat. No. 5,686,375 discloses a hydroprocessing catalyst that contains an overlayer of a Group VIB metal (preferably molybdenum) component on a support comprising an underbedded Group VIII metal (preferably nickel) component combined with a porous refractory oxide. A preferred catalyst is essentially free of supported metal components other than molybdenum and underbedded nickel. A most highly preferred embodiment of the catalyst contains above 3 weight percent of nickel components, including underbedded nickel components encompassing at least 4.5 weight percent of the support. The median pore diameter of the catalyst usually lies in the range of from about 60 to about 120 angstroms, and, typically, the surface area is greater than about 100 m²/gram. While the catalyst is used in hydroprocessing methods such as desulfurization and denitrogenation, there is no indication that the process is selective to desulfurization. The catalyst has a relatively high surface area with a small median pore size and requires an underbedded metal component that is calcined with the support material.

As may be seen from the above review of some of the prior art, there is great interest in the development of processes that provide for the selective catalytic hydrodesulfurization of sulfur-containing naphtha or hydrocarbon feedstocks that boil in the gasoline range and contain high olefin contents. By the selective hydrodesulfurization of the sulfur without significant simultaneous saturation of the olefins, the loss in octane of the feedstock may be minimized.

It is an object of this invention to provide a catalyst and process that provides for the selective desulfurization of a sulfur-containing hydrocarbon feedstock that has a high olefin content.

The catalyst composition of the invention comprises a support, wherein said support consists essentially of alumina and an amount of silica in the range of from 0.3 wt % to 10 wt % of total weight of said support, a cobalt component, and a high molybdenum concentration of a molybdenum component, wherein said high molybdenum concentration exceeds 12 wt % of the total weight of said catalyst composition and calculated assuming the molybdenum component is in the oxide form.

The process of the invention provides for the selective hydrodesulfurization of an olefin-containing hydrocarbon feedstock by contacting, under selective hydrodesulfurization conditions, said olefin-containing feedstock, having a feed sulfur concentration and an olefin concentration, with the catalyst composition of the invention and yielding a hydrotreated product having a reduced sulfur concentration.

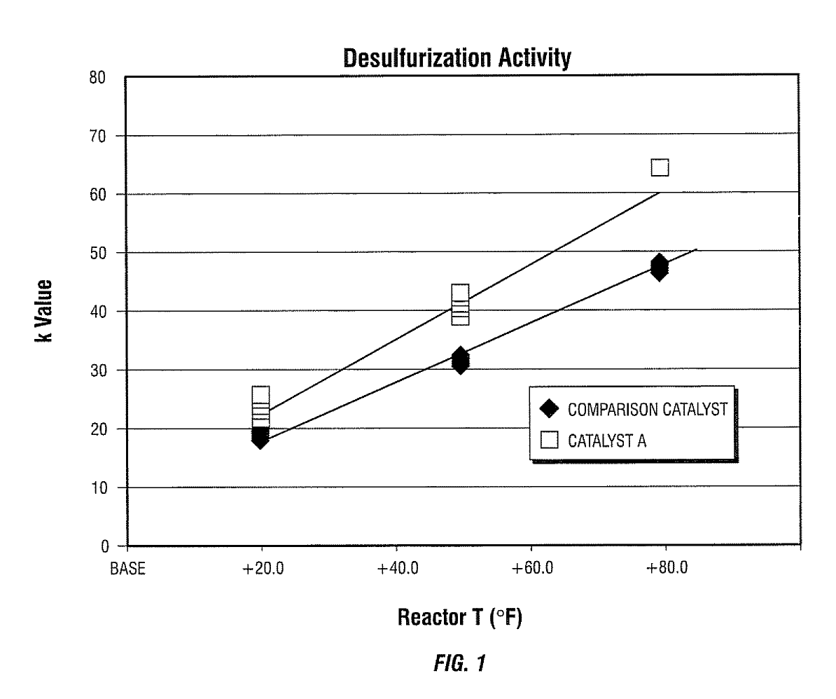

FIG. 1 presents comparative plots of the desulfurization activity of an embodiment of the inventive catalyst composition and a comparison catalyst composition versus reactor temperature.

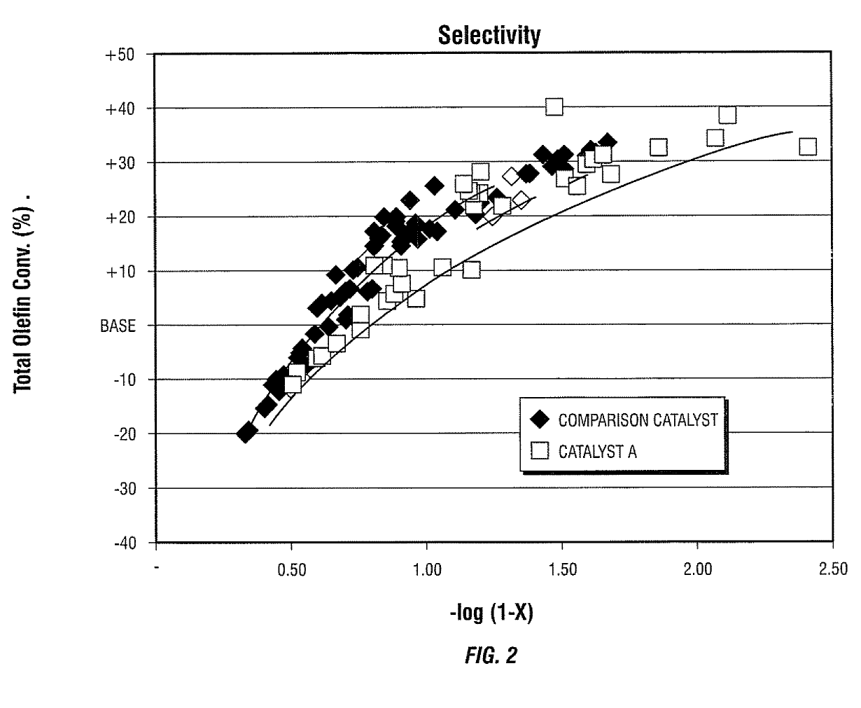

FIG. 2 presents comparative plots of the selectivity performance of an embodiment of the inventive catalyst composition and a comparison catalyst composition versus the negative log of the fraction of feed sulfur not converted (i.e., -log (1-x), where x is equal to the difference of the inlet feed sulfur concentration less outlet product sulfur concentration with this difference being divided by the inlet feed sulfur concentration).

The invention relates to a catalyst composition and a process for the selective hydrodesulfurization of an olefin-containing hydrocarbon feedstock that has a feed sulfur concentration and an olefin concentration. What is meant when referring herein to the selective hydrodesulfurization of a feedstock is that sulfur is removed from a feedstock by the catalytic hydrogenation of the organic sulfur compounds contained therein but with a minimization of simultaneous hydrogenation of the olefin compounds contained in the olefin-containing feedstock to yield a hydrotreated product having a reduced sulfur content and, preferably, a minimally reduced olefin concentration relative to the olefin concentration of the feedstock. Refinery cracked feedstocks typically contain high concentrations of sulfur as well as olefins, and it is desirable to be able to selectively desulfurize such cracked feedstocks with a minimum of olefin saturation. The inventive process and the catalyst composition used therein provide for this selective desulfurization.

The feedstocks contemplated for use in the inventive process can be a hydrocarbon feedstock that typically boils in the naphtha or gasoline boiling range, which is typically from about 10° C. (50° F.) as the initial boiling temperature to about 235° C. (455° F.) as the endpoint temperature, and, preferably from about 21° C. (70° F.) to about 225° C. (437° F.). More preferably, the hydrocarbon feedstock predominantly boils in the range of from 32° C. (90° F.) to 210° C. (410° F.). It is desirable for the feedstock to have the distillation characteristics as specified by the ASTM specifications for gasoline. These specifications vary depending upon the particular season and geographic area in which the gasoline is to be marketed. In general, the hydrocarbon feedstock of the inventive process can have a distillation characteristic as determined by the ASTM D86 method wherein the temperature at which 10% of the feedstock is evaporated (i.e., T₁₀) is at least 50° C., the temperature at which 50% of the feedstock is evaporated (i.e., T₅₀) is in the range of from 77 to 121° C., the temperature at which 90% of the feedstock is evaporated (i.e., T₉₀) is no more than 190° C., and the endpoint temperature (i.e., EP) is no more than 225° C.

The hydrocarbon feedstock of the inventive process contains both olefin compounds and sulfur compounds. The olefin content or concentration of the olefin-containing hydrocarbon feedstock of the inventive process can be in the range of upwardly to about 60 weight percent of the total weight of the hydrocarbon feedstock and usually at least 5 weight percent of the total weight of the olefin-containing hydrocarbon feedstock comprises olefin compounds. A typical olefin content of the olefin-containing hydrocarbon feedstock is in the range of from 5 weight percent to 55 weight percent of the total weight of the olefin-containing hydrocarbon feedstock, and, more typically, the range is from 8 weight percent to 50 weight percent. It is contemplated, however, that the olefin-containing hydrocarbon feedstock of the inventive selective hydrodesulfurization process can have concentrations of olefin compounds exceeding 10 weight percent and even exceeding 15 or even 20 weight percent.

Generally, the olefin-containing hydrocarbon feedstock can be a cracked naphtha product such as products from catalytic or thermal cracking units including, for example, an FCC cracked naphtha product from a conventional fluid catalytic cracking unit, a coker naphtha from either a delayed coker unit or a fluid coker unit, a hydrocracker naphtha and any combination of cracked naphtha products. The cracked naphtha product typically has a high concentration of olefin compounds and may have an undesirably high concentration of sulfur compounds.

The olefin-containing hydrocarbon feedstock of the inventive process can have a significant sulfur content or sulfur concentration that generally is in the range of from about 0.03 weight percent, i.e., 300 parts per million by weight (ppmw), to about 1 weight percent, i.e., 10,000 ppmw. More typically, the sulfur content is in the range of from 500 ppmw to 7000 ppmw, and, most typically, from 1000 ppmw to 5000 ppmw. The sulfur compounds of the olefin-containing hydrocarbon feedstock include organic sulfur compounds, such as, for example, mercaptan compounds, disulfide compounds, thiol compounds, thiophene compounds and benzothiophene compounds (including alkylbenzothiophenes and other substituted benzothiophenes). The olefin-containing hydrocarbon feedstock may also contain other hydrocarbon compounds besides paraffin compounds and olefin compounds. The olefin-containing hydrocarbon feedstock may further comprise naphthenes, and, further, comprise aromatics, and, further, comprise other unsaturated compounds, such as, open-chain and cyclic olefins, dienes, and cyclic hydrocarbons with olefinic side chains.

The olefin-containing hydrocarbon feedstock may also contain nitrogen compounds, if nitrogen compounds are present, at a nitrogen concentration in the range of from about 5 ppmw to about 150 ppmw, and, more typically, in the range of from 20 ppmw to 100 ppmw.

The inventive process provides for the selective removal of sulfur from an olefin-containing hydrocarbon feedstock, having a sulfur concentration, by catalytic hydrodesulfurization. It is understood herein that the references to hydrodesulfurization means that the sulfur compounds of a feedstock are converted by the catalytic hydrogenation of the sulfur compounds to hydrogen sulfide which may then be removed to provide a hydrotreated product having a reduced sulfur concentration. It has been discovered that the use of a specifically defined catalyst composition in the hydrodesulfurization of the olefin-containing hydrocarbon feedstock will provide for the beneficial selective hydrodesulfurization of the olefin-containing hydrocarbon feedstock as compared to the use of other conventional hydrotreating catalysts; and, therefore, an important aspect of the inventive process is the use of the particularly defined catalyst composition.

The catalyst composition of the invention that provides for the desirable selective dehydrosulfurization properties comprises a support having a specific composition, a cobalt component, and a high molybdenum concentration of a molybdenum component. The support includes alumina and an amount of silica in the range of from 0.3 to 10 wt % of the total weight of the support. The support, before incorporation therein of the cobalt and molybdenum components, preferably has a material absence of components that materially affect the finished catalyst properties of selectivity and high desulfurization activity. Thus, it is desirable for the support of the catalyst composition to consist essentially of alumina and silica and with the silica being present in the support in an amount in the range of from 0.4 to 8 wt % of the total weight of the support. Preferably, the silica is present in the support in an amount in the range of from 0.5 to 4 wt % of the total weight of the support, and, most preferably, the silica is present in an amount in the range of from 0.6 to 3 wt %.

Examples of possible components that may materially affect the catalytic properties of the catalyst composition of the invention if incorporated into its support are those as described in U.S. Pat. No. 5,266,188, such as magnesium and alkali metal. U.S. Pat. No. 5,266,188 teaches that its support comprises from about 0.5 wt % to about 50 wt % magnesium oxide and from about 0.02 wt % to about 10 wt % alkali metal oxide. The support of the catalyst composition of the invention herein should contain either less than about 0.5 wt % magnesium oxide or less than about 0.02 wt % alkali metal oxide, or it should contain both less than about 0.5 wt % magnesium oxide and less than about 0.02 wt % alkali metal oxide. Thus, the support of the catalyst composition has a material absence of these components or any other component that may materially affect the catalytic properties of the catalyst composition.

The metal components of the catalyst composition may be present therein in their elemental form or as their oxides, sulfides or mixtures of each. The form of the metal components depends upon whether or not the catalyst composition has been calcined or sulfided or reduced or some combination thereof.

It is an important aspect of the invention for the catalyst composition to have a particularly high concentration of the molybdenum component, which the molybdenum concentration should exceed 12 wt % of the total weight of the catalyst composition calculated assuming the molybdenum is present in the catalyst composition in the oxide form (i.e., MoO₃) regardless of the form in which it is actually present in the catalyst composition. The upper limit for the molybdenum concentration in the catalyst composition is no greater than 30 wt % of the total weight of the catalyst composition, thus, the molybdenum concentration can be in the range of from 12 wt % to 30 wt %. It is preferred for the molybdenum concentration of the catalyst composition to be in the range of from 14 to 25 wt %, and, most preferred, in the range of from 15 to 20 wt %.

It is believed that the cobalt of the catalyst composition is particularly effective if it is present therein in a specifically defined concentration range relative to the molybdenum content of the catalyst composition. It is thought that the relative amounts of cobalt and molybdenum present in the catalyst composition should be such that the atomic ratio of cobalt-to-molybdenum (Co/Mo) is in the range of from 0.2 to 0.7. The preferred cobalt-to-molybdenum atomic ratio is in the range of from 0.25 to 0.6, and, most preferred, it is from 0.35 to 0.45.

It is also believed that the amount of silica that is contained in the support of the catalyst composition relative to the molybdenum content of the catalyst composition impacts its catalytic performance. Thus, it is beneficial for the silica content of the support and the molybdenum concentration of the catalyst composition to be controlled so as to provide an atomic ratio of silicon-to-molybdenum (Si/Mo) that exceeds 0.2 and, generally, in the range of from 0.2 to 0.45. It is preferred for the silica content of the support and the molybdenum content of the catalyst composition to be such that the atomic ratio of silicon-to-molybdenum is in the range of from 0.24 to 0.4, and, most preferred, for the Si/Mo atomic ratio to be in the range of from 0.28 to 0.35.

Another feature of the catalyst composition is that it has a reasonably high surface area as measure by the B.E.T. method. It is beneficial for the catalyst composition to have a surface area of at least 220 m²/gram. It is preferred for the surface area of the catalyst composition to be at least 230 m²/gram, and most preferred, for it to exceed 250 m²/gram. A practical upper limit for the surface area of the catalyst composition is no more than 500 m²/gram or even no more than 450 m²/gram.

The catalyst composition of the invention may be prepared by any suitable method known to those skilled in the art that will suitably provide the catalyst composition having the properties and composition as described herein. The preferred method of preparing the catalyst composition includes the several steps of preparing the support having the specific composition and properties as described herein and incorporating into the support the metal components of molybdenum and cobalt with the resulting metal-incorporated support being calcined under suitable calcination conditions.

In the preferred method of making the catalyst composition, the support particle is first prepared by mixing the starting alumina and silica or silica-alumina or alumina and silica precursor powder with water by any suitable means or method for providing a substantially homogeneous mixture of the alumina with silica and water. Many of the possible mixing means that may suitably be used in preparing the mixture are described in detail in Perry's Chemical Engineers' Handbook, Sixth Edition, published by McGraw-Hill, Inc. at pages 19-14 through 19-24, which pages are incorporated herein by reference. Thus, possible suitable mixing means can include, but are not limited to, such devices as tumblers, stationary shells or troughs, Muller mixers, which are either batch type or continuous type, impact mixers, and any other mixer or device known to those skilled in the art and that will suitably provide the homogeneous mixture of alumina and silica or silica-alumina and water.

The amount of water mixed with the alumina and silica or silica-alumina should be such that a paste mixture is formed that can then be formed into agglomerated particles. Typically, the amount of water present in the mixture is in the range of from 30 wt % to 85 wt %, and, preferably, it is in the range of from 40 wt % to 75 wt % of the mixture. A peptizing agent, such as nitric acid or other acid, may be added to the mixture of alumina and water to assist in the dispersion of the alumina and silica or alumina-silica and the formation of the paste. It is particularly desirable for the paste to have the plasticity required for extrusion thereof.

While the formation of the agglomerate is preferably done by any of the standard extrusion methods known to those skilled in the art, other possible suitable means or methods for forming the agglomerate may include, for example, molding, tableting, pressing, palletizing, tumbling, densifying, and extruding.

The agglomerate is then dried, preferably, at a temperature in the range of from 40° C. (104° F.) to 260° C. (500° F.), and calcined to form the support particle into which is incorporated the catalytic components. The calcination is conducted in the presence of oxygen or an oxygen-containing inert gas or air. The temperature at which the agglomerate is calcined should be in the range of from 427° C. (800° F.) to 649° C. (1200° F.). The calcination time period can be in the range of from 0.5 hours to 72 hours, or even longer, if required.

The catalytic components may be incorporated into the support particle using one or more impregnation solutions containing one or more of the catalytic components. The preferred impregnation solution is an aqueous solution of the desired catalytic component or a precursor thereof.

Potential cobalt compounds that may be used in the formation of the aqueous solution include the cobalt hydroxides, acetates, carbonates, nitrates, and sulfates or mixtures of two or more thereof.

Potential molybdenum compounds that may be used in the formation of the aqueous solution include molybdenum oxide and the ammonium salts of molybdenum, such as ammonium heptamolybdate and ammonium dimolybdate.

Any suitable phosphorus containing compound may be used in the aqueous solution to provide for the phosphorus component of the catalyst composition. One such phosphorus compound is phosphoric acid.

The cobalt compound, molybdenum compound, and phosphorus compound are dissolved in water to form an aqueous solution in such amounts as to provide, when incorporated into the support particle, the desired metal concentrations in the final catalyst composition as defined earlier herein. Typically, the concentration of the metal compounds in the impregnation solution is in the range of from 0.01 to 100 moles per liter.

The impregnation may be conducted by any procedure or method or means that suitably incorporates the desired metal components in the desired amounts into the support particle. Such impregnation methods include, for example, spray impregnation, soaking, multi-dip procedures, and incipient wetness impregnation methods.

The impregnated support particle is then dried, preferably, at a temperature in the range of from 40° C. (104° F.) to 260° C. (500° F.), and calcined to form the final catalyst composition. The calcination is conducted in the presence of oxygen or an oxygen-containing inert gas or air. The temperature at which the impregnated support particle is calcined should be in the range of from 48° C. (900° F.) to 649° C. (1200° F.). But, it is particularly preferred to carefully control the calcination temperature to within the range of from 510° C. (950° F.) to 593° C. (1100° F.).

The catalyst compositions as described herein are especially useful in the selective hydrodesulfurization of an olefin-containing hydrocarbon feedstock having a feed sulfur concentration and an olefin concentration. As noted above, it has been found that the particularly described catalyst compositions can provide for improved selectivity toward the hydrodesulfurization of an olefin-containing feedstock as compared to the use other hydrotreating-type catalysts. In particular, it is the use of a catalyst composition specifically having the physical features and composition as described herein that provides for the distinctive selective hydrodesulfurization benefits of the inventive process.

The inventive selective hydrodesulfurization process includes contacting, under selective hydrodesulfurization conditions, an olefin-containing hydrocarbon feedstock as described herein with a catalyst composition as described herein, and, preferably, yielding a hydrotreated product having a reduced sulfur concentration that is much reduced below the feed sulfur concentration of the olefin-containing hydrocarbon feedstock. The inventive process can provide for a sulfur reduction in an amount greater than 15 weight percent of the sulfur contained in the olefin-containing hydrocarbon feedstock while causing less than a 25 weight percent olefin reduction by the catalytic hydrogenation of the olefin compounds contained in the olefin-containing hydrocarbon feedstock to yield the hydrotreated product.

While the sulfur reduction of at least 15 weight percent with less than a 25 weight percent olefin compound reduction is a reasonably selective hydrodesulfurization of an olefin-containing feedstock, it is desirable for the process to be more selective in the hydodesulfurization of the feedstock by providing for a higher percentage of sulfur reduction but with a lower percentage of olefin reduction. It is, thus, desirable for the desulfurization to provide for a sulfur reduction of at least 18 weight percent and even at least 20 weight percent. Preferably, the sulfur reduction is at least 25 weight percent, and, more preferably, the sulfur reduction is at least 30 weight percent. Most preferably, the sulfur reduction is greater than 32 weight percent.

It is desirable for the hydrotreated product to have a reduced sulfur concentration that is low enough so that when it is combined (after removal of the hydrogen sulfide therefrom) with other gasoline blending stocks the combination meets a significantly low sulfur target. The hydrotreated product, thus, can have a reduced sulfur concentration of less than 500 ppmw organic sulfur. It is desirable for the reduced sulfur concentration to be less than 300 ppmw, and it is more desirable for the reduced sulfur concentration of the hydrotreated product to be less than 150 ppmw. It is preferred for the reduced sulfur concentration of the hydrotreated product to be less than 100 ppmw, more preferred, less than 50 ppmw, and, most preferred, less than 10 ppmw.

Because a highly selective desulfurization process provides for a high percentage of sulfur removal with a low percentage of olefin removal by the hydrogenation of the olefin compounds in the feedstock to saturated compounds, in each of the instances noted above with respect to the sulfur reduction it is desirable for the olefin reduction to be minimized with the weight percent olefin reduction being less than 15 weight percent. Preferably, the weight percent olefin reduction is less than 10 weight percent, and, most preferably, the weight percent olefin reduction is less than 5 weight percent.

When referring herein to the weight percent sulfur reduction of the sulfur contained in the olefin-containing hydrocarbon feedstock, what is meant is that the weight percent sulfur reduction is the ratio of the difference between the weight of organic sulfur in the olefin-containing feedstock and the weight of organic sulfur in the yielded hydrotreated product divided by the weight of organic sulfur in the olefin-containing feedstock with the ratio being multiplied by the number one-hundred (100). It is understood that the concentrations of hydrogen sulfide in the olefin-containing feedstock and yielded hydrotreated product are ignored in this computation.

When referring herein to the weight percent olefin reduction of the olefin compounds contained in the olefin-containing hydrocarbon feedstock, what is meant is that weight percent olefin reduction is the ratio of the weight of the olefin compounds in the feedstock that are hydrogenated to saturated compounds divided by the weight of olefin compounds in the feedstock with the ratio being multiplied by the number one-hundred (100). The olefin compounds hydrogenated to saturated compounds is defined as being the difference between the weight of olefin compounds in the feedstock and the olefin compounds in the yielded product.

The catalyst composition of the invention may be employed as a part of any suitable reactor system that provides for the contacting of the catalyst composition with the hydrocarbon feedstock under suitable selective hydrodesulfurization reaction conditions that can include the presence of hydrogen and an elevated temperature and total pressure. Such suitable reactor systems can include fixed catalyst bed systems, ebullating catalyst bed systems, slurried catalyst systems, and fuidized catalyst bed systems. The preferred reactor system is that which includes a fixed bed of the catalyst composition contained within a reactor vessel equipped with a reactor feed inlet means, such as a feed inlet nozzle, for introducing the hydrocarbon feedstock into the reactor vessel, and a reactor effluent outlet means, such as an effluent outlet nozzle, for withdrawing the reactor effluent or low sulfur product from the reactor vessel.

The selective hydrodesulfurization reaction temperature is generally in the range of from about 150° C. to 42° C. The preferred selective hydrodesulfurization reaction temperature is in the range of from 175° C. to 400° C., and, most preferred, from 200° C. to 380° C.

The inventive process generally operates at a selective hydrodesulfurization reaction pressure in the range of from 50 psia to about 1000 psia, preferably, from 60 psia to 800 psia, and, most preferably, from 150 psia to 700 psia.

The flow rate at which the olefin-containing hydrocarbon feedstock is charged to the reaction zone of the inventive process is generally such as to provide a weight hourly space velocity (WHSV) in the range exceeding 0 hr⁻¹ such as from 0.1 hr⁻¹ upwardly to 10 hr⁻¹. The term “weight hourly space velocity,” as used herein, means the numerical ratio of the rate at which the hydrocarbon feedstock is charge to the reaction zone of the process in pounds per hour divided by the pounds of catalyst composition contained in the reaction zone to which the olefin-containing hydrocarbon feedstock is charged. The preferred WHSV is in the range of from 0.1 hr⁻¹ to 250 hr⁻¹, and, most preferred, from 0.5 hr⁻¹ to 5 hr⁻¹.

The hydrogen treat gas rate is the amount of hydrogen charged to the reaction zone with the olefin-containing hydrocarbon feedstock. The amount of hydrogen relative to the amount of olefin-containing hydrocarbon feedstock charged to the reaction zone is in the range upwardly to about 10,000 cubic meters (at standard conditions) hydrogen per cubic meter of olefin-containing hydrocarbon feedstock, but, typically, it is in the range of from 10 to 10,000 m³ hydrogen per m³ of olefin-containing hydrocarbon feedstock. The preferred range for the hydrogen-to-olefin-containing hydrocarbon feedstock ratio is from 20 to 400, and, most preferred, from 20 to 200.

The following examples are presented to further illustrate the invention, but they are not to be construed as limiting the scope of the invention.

### EXAMPLE I

This Example describes the catalyst used in the selective hydrodesulfurization experiments described in Example II. The preparation of Catalyst A and the Comparison Catalyst, which is a commercially available catalyst, are described below.

### Catalyst A

An important aspect of the invention is for the support of the catalyst composition to have a concentration of silica that is a low concentration and for the support to have a material absence of other materials that may materially affect the catalytic properties of the finished catalyst composition. The support for Catalyst A is prepared using a commercially available silica-alumina powder material, which contained 2 wt % silica with the remaining balance being substantially entirely alumina. The powder was mixed with deionized water in an amount to provide an approximate loss on ignition for the mixture of around 64 wt %. Also added to the mixture was approximately 1 wt % of a 69.8% nitric acid solution and approximately 1 wt % Superfloc 16. The mixture was extruded using 1.2 mm trilobe extrusion die inserts. The extrudate was dried at a temperature of 150° C. and then calcined at a temperature of about 593° C. (1100° F.) to provide the support. The support had a water pore volume of 0.87 cc/gram, a median pore diameter of 102 Å, as measure by mercury porosimetry.

The impregnation solution for impregnating the above-described support was prepared by separately preparing a molybdenum solution and a cobalt solution and then mixing the two to provide the impregnation solution. The molybdenum solution was prepared by mixing 25.65 parts (NH₄)₂Mo₂O₇, 7.06 parts MoO₃, 5.03 parts 30% hydrogen peroxide, and 20.91 deionized water. To this mixture 1.24 parts monoethanlamine was added in a controlled fashion in order to control the resultant exotherm. The resultant molybdenum solution was cooled. The cobalt solution was prepared by dissolving 22.52 parts Co(NO₃)₂.6H2O in 9.84 parts deionized water. The molybdenum solution and cobalt solution were combined and diluted with 82.5 parts deionized water. This final solution was used to impregnate the support.

The impregnated support was dried at a temperature of 100° C. and then calcined at a temperature of 1000° F. The composition of the final catalyst was 4.58 wt % cobalt, as an oxide, i.e., CoO, (3.6 wt % as metal), 21.30 wt % molybdenum, as an oxide, i.e., MoO₃, (14.2 wt % as metal), with the balance being the support. The final catalyst had a nitrogen surface area of 229.7 m²/g and a median pore diameter, as measured by mercury porosimetry, of 114 Å.

### Comparison Catalyst

The comparison catalyst was a commercially available catalyst having 3.4 wt % cobalt and 13.6 wt % molybdenum on an alumina support and further having a surface area of 235 m²/gram and a water pore volume of 0.53 cc/gram. This comparison catalyst contained no phosphorus.

### EXAMPLE II

This Example summarizes the experiment used to measure the performance of the catalyst compositions described in Example I in the selective hydrodesulfurization of an olefin-containing hydrocarbon feedstock having a concentration of sulfur.

The testing was performed using high throughput nanoreactors. Approximately 1 ml of crushed catalyst was used in each reactor. The feed to the reactors was a synthetically prepared gasoline feedstock that included a range of hydrocarbon components that are typically found in cracked gasoline (e.g. heptane, hexane, octane, octane, butylenes, and toluene), and it was spiked with organic nitrogen and sulfur compounds to provide concentrations thereof. The reactors were operated under suitable selective hydrodesulfurization temperature, pressure and space velocity process conditions.

Summaries of the results from the aforedescribed testing are presented for illustrative purposes in the comparative plots presented in FIG. 1 and FIG. 2.

FIG. 1 presents comparative plots, with a linear fit of the data, of the performance results for Catalyst A and the Comparison Catalyst in terms of their catalytic activity toward sulfur conversion (i.e., the k value) as a function of the reaction temperature. As may be observed from the plots of FIG. 1, the activity value exhibited by Catalyst A for a given reactor temperature is greater than that exhibited by the Comparison Catalyst for the same reactor temperature. Also, the data summarized in FIG. 1 show that the activity slope for Catalyst A is greater than the activity slope for the Comparison Catalyst, thus, indicating that Catalyst A provides for a better improvement in desulfurization activity for a given reactor temperature increase.

FIG. 2 presents comparative plots of the selectivity of Catalyst A and the Comparison Catalyst. The data summarized in FIG. 2 presents the performance results for Catalyst A and the Comparison Catalyst in terms of the percentage of olefins contained in the feed that is converted as a function of the negative log of the fraction of the sulfur contained in the feed that is not converted, i.e., 1—(feed sulfur concentration—product sulfur concentration)/(feed sulfur concentration). As may be observed from the plots of FIG. 2, for a given sulfur conversion, Catalyst A provides for a lower percentage of feed olefins conversion than that provided by the Comparison Catalyst. Thus, Catalyst A is more selective than the Comparison Catalyst in that it provides for a smaller percentage of feed olefins that is converted for a particular feed sulfur conversion.

The data summarized in this Example shows that a particular catalyst composition used under particular process conditions can provide for a selective process for the desulfurization of an olefin-containing feedstock.

That which is claimed is:

1. A catalyst composition comprising a support, wherein said support consists essentially of alumina and an amount of silica in the range of from 0.3 wt % to 10 wt % of total weight of said support, a cobalt component, and a high molybdenum concentration of a molybdenum component, wherein said high molybdenum concentration exceeds 12 wt % of the total weight of said catalyst composition and calculated assuming the molybdenum component is in the oxide form.

2. A catalyst composition as recited in claim 1, wherein said amount of silica in said support and said high molybdenum concentration are such that said catalyst composition has a silicon-to-molybdenum atomic ratio exceeding 0.2.

3. A catalyst composition as recited in claim 2, wherein said catalyst composition has a cobalt-to-molybdenum atomic ratio in the range of from 0.2 to 0.7.

4. A catalyst composition as recited in claim 3, wherein said catalyst composition has a surface area of at least 220 m²/gram.

5. A process for selective hydrodesulfurization of an olefin-containing hydrocarbon feedstock, wherein said process comprises:
contacting, under selective hydrodesulfurization conditions, said olefin-containing feedstock, having a feed sulfur concentration exceeding 0.1 wt % and an olefin concentration, with a catalyst composition comprising a support, wherein said support consists essentially of alumina and an amount of silica in the range of from 0.3 wt % to 10 wt % of total weight of said support, a cobalt component, and a high molybdenum concentration of a molybdenum component, wherein said high molybdenum concentration exceeds 12 wt % of the total weight of said catalyst composition and calculated assuming the molybdenum component is in the oxide form; and yielding a hydrotreated product having a reduced sulfur concentration.

6. A process as recited in claim 5, wherein said amount of silica in said support and said high molybdenum concentration are such that said catalyst composition has a silicon-to-molybdenum atomic ratio exceeding 0.2.

7. A process as recited in claim 6, wherein said catalyst composition has a cobalt-to-molybdenum atomic ratio in the range of from 0.2 to 0.7.

8. A process as recited in claim 7, wherein said catalyst composition has a surface area of at least 220 m²/gram.

9. A method of preparing a catalyst composition, wherein said method comprises:
preparing a support consisting essentially of alumina and an amount of silica in the range of from 0.3 wt % to 10 wt %;
incorporating into said support a cobalt component and a molybdenum component; and
calcining the resulting metal-incorporated support under calcinations conditions to thereby provide said catalyst composition.

10. A method as recited in claim 9, wherein said amount of silica in said support and said high molybdenum concentration are such that said catalyst composition has a silicon-to-molybdenum atomic ratio exceeding 0.2.

11. A method as recited in claim 10, wherein said catalyst composition has a cobalt-to-molybdenum atomic ratio in the range of from 0.2 to 0.7.

12. A method as recited in claim 11, wherein said catalyst composition has a surface area of at least 220 m²/gram.

13. A catalyst composition as recited in claim 1, wherein said amount of silica in said support is in the range of from 0.4 wt % to 8 wt %.

14. A catalyst composition as recited in claim 4, wherein said amount of silica in said support is in the range of from 0.5 wt % to 4 wt %.
